(19) United States
(12) Patent Application Publication
(10) Pub. No.: US 2026/0106754 A1
(43) Pub. Date: Apr. 16, 2026

(54) LIGHTWEIGHT, BLOCKCHAIN-BASED REPUTATION SYSTEM FOR UNMANNED AERIAL VEHICLE NETWORKS

(71) Applicant: Government of the United States as represented by the Secretary of the Air Force, Wright-Patterson AFB, OH (US)

(72) Inventors: Yu Chen, Vestal, NY (US); Simeon Ogunbunmi, Vestal, NY (US); Ronghua Xu, Houghton, MI (US); Erika Ardiles-Cruz, New Hartford, NY (US); Alex Aved, Rome, NY (US); Erik Blasch, Arlington, VA (US)

(21) Appl. No.: 19/330,203

(22) Filed: Sep. 16, 2025

Related U.S. Application Data
(60) Provisional application No. 63/705,556, filed on Oct. 10, 2024.

(51) Int. Cl. H04L 9/32; H04L 9/00; H04W 12/60

(52) U.S. Cl. CPC H04L 9/32; H04L 9/002; H04L 9/50; H04W 12/66

(57) ABSTRACT

A system includes: one or more each of UAVs; UAV service requestors; UAV service providers; and ground stations. Using an identity authentication module, a reputation system module, and a blockchain fabric module, the UAVs, the UAV service requestors, the UAV service providers, and the ground stations are capable of sending and receiving electronic data via one or more remote connections, the identity authentication module identifies and authenticates UAVs such that only verified and authenticated UAVs can access the UAV network; the reputation system module evaluates and maintains a reputation of the UAV service requestors and the UAV service providers and assigns a reputation; and the blockchain fabric module implements a blockchain with respect to the UAV network to securely record flight data of the UAVs on the UAV network, which flight data includes one or more of a location, altitude, and one or more mission parameters of the UAV.

Pursuant to 37 C.F.R. § 1.78(a)(4), this application claims the benefit of and priority to prior filed co-pending Provisional Application Ser. No. 63/705,556, filed Oct. 10, 2024, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to unmanned aerial vehicle (UAV) networks and, more particularly, to reputation systems for UAV networks.

### BACKGROUND OF THE INVENTION

The market for unmanned aerial vehicles (UAVs), also referred to as drones, has grown rapidly. Drones have been widely adopted for both civilian and military applications, including delivery, transportation, inspection, mapping, etc. Data received via UAV(s) can be essential for emergency operations. UAVs have different applications than many other robotic vehicles, as they are generally not limited to surface operations. They may be more agile and adaptable than other robots for many tasks. This may make them ideal for tasks in remote work sites.

The use of drones remotely, though, can be challenging from a command and control perspective. Each UAV can be a complex Internet of Things (IoT) system, consisting of sensors, antennae, embedded software, communications hardware and software, etc. Interweaving only one of these complex drones can be difficult. Having multiple drones operating in the same environment makes the situation even more challenging. Especially when considering that, in addition to the organic challenges of simply operating, drone systems and networks may be vulnerable to malicious attacks.

The proliferation of UAVs and their application has made UAV networks attractive targets. During encrypted data exchanges between UAV systems and unauthorized entities, for example, sensitive and private information, such as position, payload, and flight time, may be made public. The confidentiality, reputation, privacy, security, and reliability systems of these networks can be attacked. The constrained nature of computing resources and limited power supplies in drones may make drones particularly vulnerable to attack.

Because the reliability and credibility of UAV networks are paramount, new systems and methods for protecting these UAVs and the payloads and information they carry using a lightweight, blockchain-based reputation (LIBRE) system may be required.

### SUMMARY OF THE INVENTION

The present invention overcomes the aforementioned problems and other shortcomings, drawbacks, and challenges of resource constraints, centralized vulnerabilities, inadequate trust management, limited scalability, interoperability challenges, lack of transparency and auditability, and adaptability to dynamic environments. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a system includes a UAV network including one or more of: one or more UAVs; one or more UAV service requestors; one or more UAV service providers; and one or more ground stations, an identity authentication module, a reputation system module, and a blockchain fabric module. The UAVs, the UAV service requestors, the UAV service providers, and the ground stations are capable of sending and receiving electronic data via one or more remote connections, the identity authentication module identifies and authenticates the UAVs in the UAV network such that only verified and authenticated UAVs are capable of accessing the UAV network; the reputation system module evaluates and maintains a reputation of one or more of the UAV service requestors and the UAV service providers assigning a reputation rating for one or more of the UAV service requestors and the UAV service providers. The blockchain fabric module implements a blockchain with respect to the UAV network to securely record flight data of the UAVs on the UAV network, which flight data includes one or more of a location, altitude, and one or more mission parameters of the UAV.

According to another embodiment of the present invention, a method comprises registering a first UAV on the UAV network using the identity authentication module, registration of the first UAV including a configuration of node settings for participation in the UAV network; verifying the first UAV on the UAV network, verification of the first UAV including one or more of an identity verification using one or more of a public key infrastructure with a cryptographic key or a digital signature; performing of transaction with the first UAV on the UAV network; updating a reputation of the first UAV on the UAV network by performing a reputation score calculation; determining whether the first UAV is a malicious actor on the UAV network based, at least in part, on a result of the reputation score calculation; providing access to the UAV network for the first UAV based on a determination that the first UAV is not a malicious actor and restricting access to the UAV network based on a determination that the first UAV is a malicious actor.

Additional objects, advantages, and novel features of the invention will be set forth in part in the description which follows, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows a system architecture for a lightweight, blockchain-based reputation (LIBRE) system for unmanned aerial vehicle networks.

FIG. 2 shows a method for using a LIBRE system for unmanned aerial vehicle networks.

FIG. 3 shows results of testing using various UAVs in a LIBRE system for unmanned aerial vehicle networks.

FIG. 4 shows additional results from testing various UAVs in a LIBRE system for unmanned aerial vehicle networks.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some embodiments of the present invention. Furthermore, these are examples of reduction to practice of the present invention and confirmation that the principles described in the present invention are therefore valid but should not be construed as in any way limiting the scope of the invention.

As mentioned above, the reliability and credibility of UAV networks is of paramount importance to protect the data and payloads these UAVs carry. Like any other network, UAV webs may consist of a collection of nodes with one or more interfaces between them. A reputation system can aggregate the interactions between nodes and enable the establishment of individual UAV profiles that reflect system-level and individual-level performance. Reputation scores can serve as indicators of security, privacy, and decision-making confidence, providing valuable insights into the level of trustworthiness of individual or groups of nodes (e.g., UAVs). One such reputation framework is a blockchain. Blockchains are decentralized and transparent ledgers with characteristics such as audibility, immutability, traceability, and transparency. Blockchains can enhance privacy and security in data transmission with features such as peer-to-peer and cryptography consensus algorithms. Blockchains have achieved transparency characteristics between different non-trusted entities. In embodiments described herein, a blockchain-based reputation system, which may be classified as lightweight (hence, a “lightweight, blockchain-based reputation (LIBRE) system”), may help to monitor, track, and select suitable drones for drone task execution.

As background, a blockchain can be based on a distributed database with a scalable list of data entries. Information blocks can include a timestamp, an encrypted hash value, and a data transaction from one or more preceding linked blocks. In a blockchain network, when nodes exchange information or assets, they initiate a transaction. A source node can create a transaction file and the transaction file may be broadcast to the network or to one or more specific nodes for validation. Validated transactions can be grouped into blocks and added to the blockchain based on a consensus mechanism. That is, whatever consensus mechanism(s) employed by the particular blockchain.

Blockchains, with their inherent trust-enhancing mechanisms, may be particularly useful in networks of robots that are configured to swarm. By definition, a swarm requires near-instantaneous and ubiquitous communication between nodes. If swarm communications are unable to be verified, individual nodes will either not accept the communication or the entire swarm could be susceptible to misuse. A blockchain can provide these types of networks communications tools which may be relatively difficult to corrupt, making them an ideal tool.

Integration of blockchain technology has proven effective in mitigating various attacks in UAV systems, including Sybil attacks, Man-in-the-Middle attacks, jamming, Distributed Denial of Service (DDoS) attacks, and more. Integrating blockchain enables the establishment of trust and ensures data immutability and transparency within UAV systems. The Autonomous Intelligent Robot Agent (AIRA) protocol is introduced to address the limitations of a centralized system. This AIRA protocol utilizes blockchain platforms (e.g., the Ethereum platform, etc.) to manage economic interactions in a multi-agent system. The AIRA protocol combines smart contracts, one or more operating systems (e.g., a Robot Operating System), file management systems e.g., an InterPlanetary File System) for data storage, and one or more virtualization tools (e.g., Docker, etc.). Transactions in the system can involve tokens (e.g., Ethereum tokens, custom tokens, etc.). The AIRA protocol can be implemented in drones, and these drones may be utilized for navigation, regulatory compliance, and economic activities. Implementing the AIRA protocol in drones may involve service requests, smart contract creation, service acceptance by UAV agents, and approval of air corridors by agent dispatchers.

A decentralized platform within an air-to-ground heterogeneous network may be used to address the constraints of IoT devices and support UAV-based applications securely and autonomously receiving sensor data. In turn, this may enable information storage and trading. The systems and methods described herein introduce a blockchain architecture that effectively addresses computation and storage overhead while maintaining privacy, security, and lightweight characteristics.

Additionally, UAVs may serve as edge data collection nodes. Regularly cruising and recharging may facilitate long-term data collection and stable network access. Blockchain technology may also perform a crucial role in developing centralized solutions through the introduction of various protocols. For example, UGG/IPP and LPP algorithms may be used for dynamic encryption. Decentralized architectures can leverage hash functions to enhance storage and processing efficiency utilizing blockchain, which may provide a secure and tamper-resistant framework for storing and managing identities. Periodic updates and calculation of real identities can improve system performance, reduce processing time, and enhance privacy protection.

A reputation system or trust and reputation model (TRM), as described herein, can evaluate the trustworthiness and trust of entities such as users, service providers, or peers based on their previous behavior, interactions, and feedback. A TRM can protect large distributed sensor networks in IoT/cyber-physical systems (CPS) from malicious node attacks. Without a TRM, nodes may be unable to collaborate, detect untrustworthy entities, or assist in decision making processes. In some embodiments, a TRM-IoT may promote cooperation between nodes based on behaviors. The model's accuracy, robustness, and efficiency can be validated through extensive simulations.

Some embodiments of trust and reputation systems may utilize fog computing. In fog computing, fog nodes may evaluate trust levels among IoT devices, allowing interactions only with devices that meet a predefined trust threshold. This evaluation process can help prevent malicious devices from impacting systems, compromising the quality of service, and preventing or inhibiting attacks such as bad mouthing, on-off, and self-promoting attacks. In some embodiments, an event-based reputation model can be used to filter false event message in a multi-UAV network. In such a model, each event may embody two distinct roles and implement a dynamic mechanism for role development, reputation, and evaluation. The mechanism can help to determine the trustworthiness of incoming messages and prevent the spread of false event messages amongst UAVs in a network. Additionally, networks may utilize an enhanced condensed hierarchical clustering method that utilizes user preference similarity to improve the accuracy of recommendation trust. The method can employ a cloud model-based technique to measure similarities between users and then apply the hierarchical clustering method to group users into different domains based on their similarities. This process can obtain a final recommendation trust, which may include both intra-domain and extra-domain recommendation trust. The overall trust in cloud services can be evaluated by considering both direct trust and recommended trust.

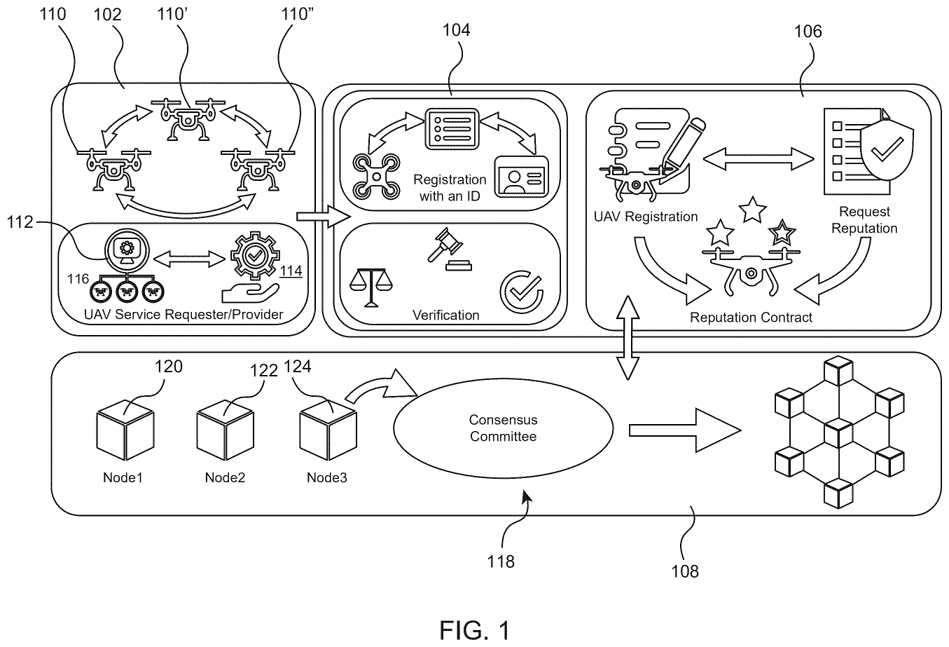

In combination, a blockchain and reputation system can enhance a quality of service (QoS) and security in drone applications (e.g., package delivery, surveillance, environment monitoring, etc.) FIG. 1 shows a system architecture 100 for a system including at least four subsystems: a UAV network 102, an identity authentication module 104, a reputation system module 106, and a blockchain fabric module 108.

The UAV network 102 may include multiple drones 110, 110′, 110″, etc. (or “UAVs”, “devices”, etc.—it is to be understood that while three drones are depicted, a UAV network can include any number of drones) a UAV service requestor 112 and/or a UAV service provider 114. The drones 110 may be connected with one or more ground stations 116. The drones 110, the UAV service requestor 112, the UAV service provider 114, and/or the one or more ground stations 116 may be connected via one or more remote connections in the UAV network 102 (e.g., Wi-Fi or other wireless connection, cloud network, wired connection(s), etc.) as one or nodes in the UAV network 102. The UAV network 102 may serve as a physical infrastructure for the system, enabling UAVs to connect, share data, and carry out specific functions to provide intelligent air mobility applications.

In some embodiments, the drones 110 may sense the environment, collect data, and communicate with one or more ground stations connected to the UAV network 102. The drones 110 may execute activities and services on the UAV network 102. The UAV service providers 114 may provide services needed in the system and have individual nodes registered on the network by interacting with a registration contract. They are responsible for the maintenance and operation of the UAVs, as well as the provision of flight services to users. UAV service requestors 112 may cause drones 102 to perform tasks such as aerial photography, surveillance, and delivery. The ground stations 116 may deliver commands to the UAVs, receive data from them, and provide power to them. The ground stations 116 may serve as control centers for overseeing and directing drone operations for simplifying data sharing and control centers or communication hubs for managing and coordinating drone operations.

The identity authentication module 104 may ensure the authenticity and identity verification of UAVs in the network. It can employ mechanisms to validate the identification of each drone 110, through digital signatures, cryptographic keys, or other secure means. Only registered, verified, and authenticated UAVs can access the network and participate in its activities. This authentication mechanism assists in the prevention of unauthorized access, potential security breaches, and the involvement of malicious or untrustworthy entities.

The identity authentication module 104 may use a consensus mechanism such as, for example, proof of work, proof of stake, delegated proof of stake, practical byzantine fault tolerance, proof of authority, proof of space and time, federated byzantine agreement, etc., to verify transactions on the UAV network. The individual nodes may work together to agree on a state of the blockchain based on one or more validated transactions. When a transaction is broadcast, one or more of the individual nodes may check if it adheres to the rules of the blockchain (e.g., the drone 110 is authenticated, etc.) The individual nodes may verify new blocks proposed by the other nodes in the blockchain, which can include checking transactions within a block and ensuring it references other correct previous blocks. The UAV network 100 may be decentralized because multiple nodes may independently verify transactions and blocks. That is, the system 100 may exhibit redundancy, enhancing security and trust. In embodiments, the system 100 may further execute smart contracts, ensuring that transactions follow agreed-upon logic, as discussed in greater detail herein. In a traditional, centralized system, all data and authority reside in a single server. If that server fails or is compromised, an entire network outage may be experienced. This is known as a single point of failure. The UAV blockchain network eliminates this vulnerability through redundancy. This means the same information (the blockchain ledger) and the same capabilities (transaction verification) are copied and distributed across many different nodes (the drones). This duplication ensures that the failure of one, or even several, nodes does not compromise the network's integrity or operation. Consider three examples in a network of 50 UAVs, each UAV referred to as a serialized UAV within the network (i.e., “Drone #27, Drone #15, etc.) (1) Physical Drone Loss or Corruption: Drone #27 is physically damaged during a mission and goes offline permanently. In a centralized system, if Drone #27 were the main server, its loss could be catastrophic. In the blockchain network, integrity of network data will less effected. The other 49 drones can maintain an otherwise identical, up-to-date copy of the entire transaction history. The network continues to operate seamlessly despite the loss of Drone #27. When a new drone, Drone #51, joins the network, it can download the complete, verified ledger from any of the other active nodes. (2) Malicious Data Tampering: In some eventualities, an attacker may gain control of an exemplary node (e.g., Drone #15) and attempt to alter a past transaction on its local copy of the ledger, for instance, to fake its authentication credentials. The attempt may fail immediately. When Drone #15 communicates with the network, its version of the blockchain history will not match the version held by the other 49 drones. The consensus rules will automatically reject any transactions or blocks coming from Drone #15 because its ledger is different from the established, majority-held truth. To successfully alter the ledger, the attacker would need to control more than half of the network's nodes (i.e., twenty-six or more drones) simultaneously, which is practically infeasible. (3) Invalid Transaction Broadcast: A malfunctioning drone (e.g., Drone #42), accidentally broadcasts a technically invalid transaction, perhaps a flight plan that uses an incorrect data format or violates a pre-programmed airspace rule. The transaction is not sent to a single authority for approval. Instead, it's broadcast to all available nodes. Drones #5, #12, #33, for example, and others will each independently try to validate the transaction. They will all run the same checks and conclude that it violates the network's rules. Because there is no consensus on its validity, the transaction is rejected and never added to the blockchain. The redundant verification process acts as a distributed firewall, catching errors or malicious actions.

The reputation system module 106 may evaluate and maintain a reputation of one or more of the UAV service requestors 112 and the UAV service providers 114 based on, for example, their behavior, dependability, and adherence to network rules. The reputation system module 106 may track each UAV's activities and performance and may assign reputation ratings based on the actions and results of the UAV. Provider reputation ratings may be based on, for example, performance, responsiveness, task completion, interactions, honesty, promptness in executing obligations, and adherence to safety regulations.

The reputation system module 106 may be designed to assess and reflect the trustworthiness and reliability of participants (users, nodes, or entities) within the network.

The reputation system module 106 may use or exhibit one or more of the aspects, such as, for example, trust building, transaction validation, incentive alignment, risk assessment, decentralized governance, dispute resolution, and/or one or more feedback mechanisms. Trust Building: the reputation system module 106 may help establish trust among participants by providing a score or ranking based on past behavior. This can be used, for instance, in a decentralized network where participants may not know each other. Transaction Validation: In some systems, a participant's reputation can influence their ability to validate transactions or propose new blocks. Higher reputation might lead to more responsibilities and opportunities. Incentive Alignment: Users are motivated to act honestly and responsibly to maintain or improve their reputation. This can reduce malicious activities, as bad behavior can lead to a loss of reputation and opportunities. Risk Assessment: Reputation scores can be used to assess the risk of engaging in transactions with certain participants. This can help users make informed decisions about whom to trust. Decentralized Governance: Reputation can play a role in governance models, where users with higher reputation may have more voting power or influence over decisions in the network. Dispute Resolution: In the event of conflicts or disputes, a reputation system can provide context and history that helps resolve issues based on past behavior and interactions. Feedback Mechanism: The reputation system module 106 can incorporate feedback from peers, allowing users to rate and review each other, which can enhance transparency and accountability.

The blockchain fabric module 108 may implement a blockchain within the UAV network 102. As described herein, a blockchain is a decentralized network that can provide a space where no one organization has total authority. This decentralization can enhance the network's fault tolerance and resilience since different drones can communicate and cooperate without depending on a centralized authority. Additionally, blockchain provides trust and transparency through its transparent and immutable ledger. In a drone network, this ensures secure recording of flight data, including location, altitude, and mission parameters. Transparency can build trust among network participants and safeguards the integrity of the collected data.

The blockchain fabric module 108 may be a component or framework used in the development and deployment of the blockchain network. The blockchain fabric module 108 can have, for example, a modular architecture that may allow developers to plug in various components (e.g., consensus mechanisms, membership services, identity management, etc.) Various smart contracts may be written in the blockchain fabric module 108 in various programming languages (e.g., Go, Java, JavaScript, etc.) The blockchain fabric module 108 may support private channels, which can allow specific participants to conduct transactions without sharing details with the entire network, enhancing confidentiality in enterprise scenarios. The blockchain fabric module 108 may include a robust membership service provider that may manage identities and permissions, ensuring that only authorized users can access certain features of the UAV network 100. The blockchain fabric module 108 may include one or more pluggable components, which may enable customization of various elements, including consensus algorithms, transaction ordering, and data storage, to tailor the blockchain network to specific use cases. The blockchain fabric module 108 shows how transactions may be validated and permanently recorded on the blockchain through a committee-based consensus mechanism 118. Specifically, the blockchain fabric is the foundational layer that ensures the integrity and security of the entire system. It functions as the network's distributed database. (1) Nodes (e.g., Node 1 120, Node 2 122, Node 3 124) represent the individual UAVs participating in the blockchain network. The number of nodes in the network is unlimited. Each node maintains a copy of the entire blockchain ledger. When a new transaction occurs (like a UAV registration from the module above), it is broadcast to these nodes. (2) Instead of having every single node in the network compete to validate transactions (as in Proof of Work), this diagram shows a Consensus Committee. The Consensus Committee is a designated group of nodes responsible for verifying transactions and agreeing on the state of the ledger. This model is often used in more controlled or private blockchains (like a dedicated UAV network) because it is faster and more energy efficient. The nodes essentially submit proposed blocks of transactions to this committee for approval. (3) The committee runs a consensus algorithm to agree that all transactions in a proposed block are valid. Once they reach this agreement, or consensus, the block is considered finalized. (4) The finalized block is then cryptographically linked to the previous block in the chain, creating a permanent, tamper-proof, and immutable record. The blockchain can be built on, for example, on the Ethereum platform or another blockchain platform (e.g., Solana, Cardano, Avalanche, Polkadot, etc.) or can be compatible with the Ethereum platform or another blockchain platform. Accordingly, the network can execute smart contracts (like the “Reputation Contract”) using the appropriate blockchain protocols.

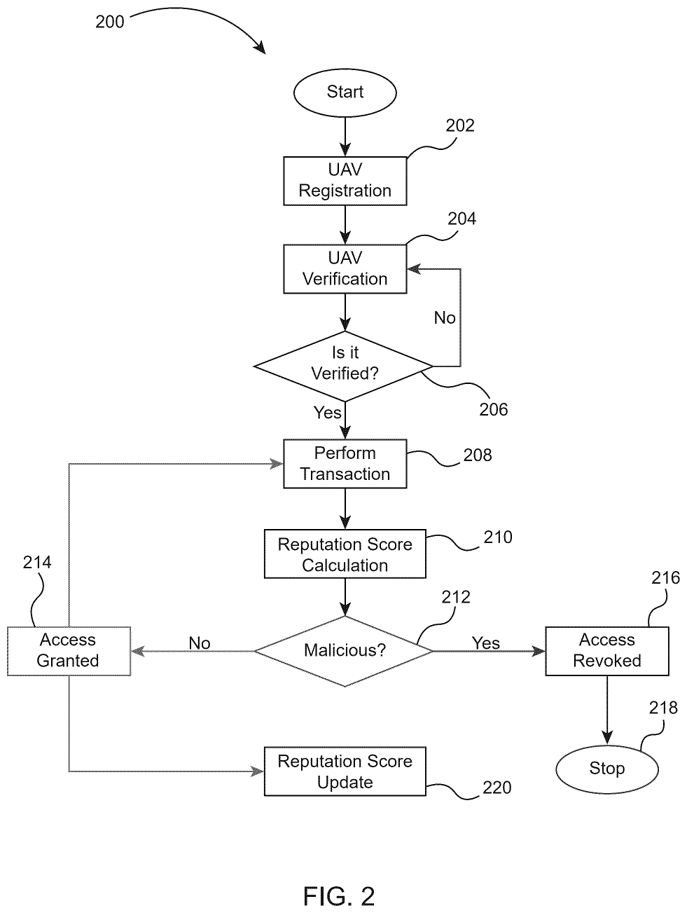

FIG. 2 shows a process 200 for implementing the UAV network 102 of FIG. 1. The process 200 may manage the registration, verification, reputation calculation, and updating of the reputation scores for service providers. The system architecture can be implemented using a smart contractor developer (e.g., Remix IDE, etc.) and may use a reputation calculation equation to calculate a reputation for one or more the drones 110, UAV service providers 114, or UAV service requestors 112. The reputation calculation equation may be used to calculate a reputation score of each device after each successful transaction made by each UAV service provider 114 based on, for example, weight factors, rating, number of tasks completed, etc. Separate smart contracts can be developed to ensure separate reputation operations for the UAV service providers. For UAV service providers 114, the reputation system contract can maintain the reputation system and reputation management.

Still referring to FIG. 2, at step 202, a UAV registration may occur. The UAV registration can be managed by, for example, a UAV registration contract (e.g., a registration contract developed with a generative smart contract developer, etc.) A reputation system interface can be used in the UAV registration contract to implement UAV registration. At step 204, the UAV may be verified at a UAV verification step. The UAV verification step may also utilize the reputation system interface, which may also initiate the reputation score updating process. From the reputation system contract, an initial UAV's reputation score can be generated, for example, using the registration module 104 in FIG. 1. This smart contract may enable the registration of the service provider with a given specific name using a string parameter representing the UAV to be registered. In some instances, an empty name field may not be recognizable by the system. A specific name may be needed to be given to each registered UAV. In some embodiments, the system may be capable of assigning names to UAVs which may not already have them in the system. The reputation system contract may determine whether a UAV is registered or verified by the name and the address used during registration.

In some embodiments, registration and/or verification of the UAVs and other system nodes can include one or more steps. For instance, a node type may be chosen (e.g., a full node, a light node, a validator node, etc.) In embodiments, a full node may store an entire blockchain and participates in validation, a light node may store only a portion of the blockchain and may rely on full nodes for, for example, transaction verification, a validator node may be used on networks that use proof-of-stake or similar mechanisms. The registration/verification may set up the environment based on hardware and/or software requirements. For example, the registration/verification may ensure that a node has the necessary hardware specifications (CPU, RAM, storage) and that the required software (node client) installed. In embodiments, the registration/verification may generate cryptographic keys. For example, a public/private key pair. Nodes need to generate a cryptographic key pair for identity and transaction signing. The public key can be shared with the network, while the private key is kept secure.

The registration/verification may configure individual node settings, such as, for example, a network configuration. The node settings can include, for example, a structured set of configuration parameters that govern the behavior, identity, and role of each node within the system. It may adjust settings such as network addresses, port numbers, and protocols according to requirements and may define a node's role (e.g., miner, validator, etc.) based on the network's consensus mechanism. The registration/verification may carry out a registration process. For example, on permissioned blockchains, the registration/verification may be undergone to gain access and start providing service in the system, providing identity verification documents. The registration/verification may also handle approval of individual nodes: A governing entity or consensus among existing members may approve the application. The registration/verification may also assign a unique identity to the nodes within the network upon approval. In permissionless blockchains, for example, nodes may use self-registration, meaning that nodes can typically join the network freely by connecting to it and broadcasting their public key. A new node may sync with the existing blockchain to download the current state and transaction history in an initial sync. The registration/verification may also be responsible for network integration, including node discovery and peer connections. A new node needs to discover other nodes in the network to establish connections. This can be accomplished through, for example, a seed node or a predefined list of nodes. A node connects to other peers to start participating in the network. After registration, nodes often undergo testing to ensure they are correctly integrated into the network. Monitoring tools can help track performance and health. Regular updates to software and monitoring may be used to register/verify nodes and may be essential to maintain node performance and security. Nodes that do not participate in regular updates to software and/or allow monitoring may not be allowed to participate in the network.

As alluded to above, the node settings can include node identity, including a unique cryptographic identifier (such as a public key or node ID), optional owner information, registration timestamps, and any associated proof of identity or ownership. Next, node role and type parameters can determine a node's function—e.g., whether it acts as a validator, observer, auditor, etc.—along with a permission level(s) and/or scope of participation in the network. Additionally, node settings can include initial reputation parameters, which may include an initial reputation score, mechanisms for reputation accrual or loss, and associations with trust anchors that vouch for the node's credibility.

Node settings can further include settings related to resource constraints and operational limits. Resource constraints and operational limits can define throughput caps, storage capacity, and uptime expectations. The verification status of a node can, for example, track whether it has been fully or partially verified, the method of verification (manual, automated, or third-party), and applicable status flags (e.g., “active,” “suspended,” etc.) To ensure network security, node settings can include security settings. Security settings may define authentication methods, key rotation policies, and any attestation proofs (e.g., from trusted hardware environments). Communication parameters specify technical details such as endpoint addresses, encryption requirements, and expected heartbeat or ping intervals.

With respect to governance, compliance and jurisdictional information may be included in the node settings, covering legal limitations, regulatory compliance flags, and whether a node is eligible to vote on network governance decisions (e.g., within the consensus mechanism 118). In embodiments, custom metadata can be assigned within node settings, which can enable more descriptive tagging and classification of nodes, such as software versioning, operational intent, and any specific policies defined at the time of registration. Additionally, a secure registration signature, including a cryptographic approval from the registration module and a hash of the configuration data can ensure integrity and authenticity of a node's registration details.

Once the registration and verification of the provider are completed, the reputation system contract may set the reputation score using the reputation score calculation at step 210. The prior reputation score may be set to zero which can be mapped using the name and address as the key. The reputation system contract may return a Boolean output of a verification function to be true if the UAV device is verified and may return false if the UAV is not verified. In some embodiments, transactions cannot be completed without a complete verification of the UAV device at step 206 as shown in FIG. 2.

The reputation score of a device can be increased or decreased at step 210 based on transaction performance at step 208, like packet delivery in UAV networks, which operate across multiple layers and directly affect transaction performance between nodes. Transaction performance is sensitive to packet loss, which is higher in UAV environments due to mobility, dynamic topologies, and limited transmission ranges. When, for example with reference to the multiple nodes in FIG. 1, Node 1 120 transmits service acceptance messages to Node 2 122, packets may follow different routes through relay UAVs (e.g., Node 3 124, etc.) Network congestion from concurrent transactions can cause queuing delays and buffer overflows. The constantly changing positions of UAVs necessitate real-time route discovery and maintenance, which adds overhead to each transaction. Packet reliability is critical for maintaining blockchain transaction integrity, as incomplete or corrupted smart contract data can lead to failures or require retransmissions. LIBRE's reputation calculations rely on accurate feedback transmission, where even a single lost packet can skew scores.

This continuous calculation can substantially affect the reputation, trustworthiness, and/or the scores of the UAV devices either positively or negatively after a prior reputation calculation has been calculated. Reviews/feedback can be given after each successful transaction based on different metrics (e.g., delivery level, performance, delivery time, meeting the set rules and regulations, reliability, etc.) The system may be set to prioritize various factors associated with the UAV's effectiveness including, for example, timeliness, quality of delivery, etc. These factors may affect the rating using a weighting factor. Feedback can be given based on the rating and weight factors and it can be calculated and updated using, for example, the reputation contract.

A reputation score of each device can be calculated using a reputation calculation equation, Eq. (1), by finding the summation of all prior reputation scores, and then finding the division of this sum with the total amount of tasks the device has completed as shown in Eq. (2).

$$PR = \frac{( WQ * RQ ) + ( WT * RT )}{10} \qquad ( 1 )$$

$$RI = {\sum }_{1}^{n} \frac{PR}{TT} \qquad ( 2 )$$

### Where:

WQ: the weight factor of Quality of Delivery
RQ: the reputation score of Quality of Delivery
WT: the weight factor of Timeliness
RT: the reputation score of Timeliness
TT: the Total Task Completed
PR: the Prior Reputation

The reputation calculation process in the LIBRE system involves aggregating feedback and performance data to produce a trust score for each UAV. The core of this process is the reputation score calculation, which considers multiple dynamic weighted factors such as ratings, the number of tasks completed, and the quality of service provided. The weighted factors can change for any given reputation calculation based on a reputation history of the given UAV (or lack thereof) and a nature of a task to be completed by the UAV.

When a UAV completes a task, its performance is evaluated based on feedback from other nodes, which is then submitted to the smart contract. This feedback includes ratings that reflect the UAV's behavior, accuracy, and timeliness. The equation combines these ratings with predefined weights, such as the importance of quality versus timeliness, to compute an updated reputation score. For example, higher ratings and more consistent positive feedback increase the score, indicating trustworthy behavior. Negative feedback or inconsistent evaluations decrease the score, signaling potential malicious or unreliable activity. The calculation also accounts for the number of tasks completed, ensuring that reputation reflects sustained performance rather than isolated incidents. Once computed, the new reputation score is stored immutably on the blockchain, ensuring transparency and resistance to tampering. This score influences future access decisions, with lower scores leading to revocation of network privileges for untrustworthy nodes. The process creates a dynamic feedback loop where UAVs' reputation scores evolve based on ongoing performance, promoting honest behavior and deterring malicious actions within the network.

At step 212, the system may determine whether a particular node (i.e., a UAV, a service provider, or a service requestor) is malicious. A node with a lower reputation score may indicate that it has the potential or has already produced services that cause attacks and harm to the system and accordingly the access of the node or such service provider can be revoked at step 216 to prevent malicious attacks on the system. A malicious provider can pass through the registration and verification process without being detected as malicious but can be detected once service is rendered on the system at step 208. The calculated reputation score can then be updated at step 220 and saved on the blockchain to ensure the immutability, transparency, and decentralization of the system.

Access granted in the LIBRE system functions as the decision point that allows a UAV to participate in further network activities after passing certain trust evaluations. It occurs after the system determines whether a device is malicious or trustworthy. Specifically, once a UAV's reputation score is assessed, based on its previous performance, feedback, and behavior, the system evaluates if the score exceeds a predefined trust threshold. If the score indicates trustworthy behavior, access is granted, enabling the UAV to perform transactions and continue its operations within the network. This process fits sequentially between malicious determination and transaction execution. First, the system assesses the UAV's behavior to identify malicious or untrustworthy nodes. If deemed trustworthy, the system grants access, allowing the UAV to engage in transactions. During or after these transactions, feedback is collected, and the reputation score is updated accordingly. This update reflects the latest performance, ensuring that future access decisions are based on current trustworthiness levels. In essence, access-granting acts as a gatekeeper that ensures only reliable UAVs participate in network activities. It relies on the reputation score, which is continuously refined through transaction performance evaluations, feedback, and subsequent updates. This cyclical process maintains the integrity and security of the UAV network by promoting honest behavior and penalizing malicious actions.

Exemplary algorithms for UAV registration and calculating node reputation (i.e., a reputation contract) are shown below:

Algorithm 1 UAVRegistration

| | |
|---|---|
| 1: | registered_names ← { } |
| 2: | verified_navs ← { } |
| 3: | procedure REGISTERUAV (name) |
| 4: | if name ≠ None and name ∉ |
| | registered_names and name ∉ verified_navs |
| | then |
| 5: | registered_names\|name\| ← False |
| 6: | end if |
| 7: | end procedure |
| 8: | procedure VERIFYU AV (name) |
| 9: | if name ∈ registered_names and name ∉ verified_uavs then |
| 10: | verified_navs[name] ← True |
| 11: | delete registered_names[name] |
| 12: | end if |
| 13: | end procedure |
| 14: | function ISU AV REGISTERED(name) |
| 15: | return name ∈ registered_names |
| 16: | end function |
| 17: | function ISUAVVERIFIED(name) |
| 18: | return name ∈ verified_uavs |
| 19: | end function |

Algorithm 2 ReputationContract

| | |
|---|---|
| 1: | struct UAV |
| 2: | struct Rating |
| 3: | mapping(address = UAV) |
| 4: | mapping(address = Rating [symbol] ) |
| 5: | public reputationScores: |
| 6: | mapping(address = uint256) public priorReputations; |
| 7: | constantMAX_SCORE = 5; |
| 8: | constantMAX_RATING = 5; |
| 9: | constantMAL_THRESHOLD = 2; |
| 10: | constantWEIGHT_QUALITY = 6; |
| 11: | constantWEIGHT_TIMELINESS = 4; |
| 12: | function SUBMITRATING(...) |
| 13: | end function |
| 14: | function CALCULATEREPUTATIONSCORE(...) |
| 16: | end function |

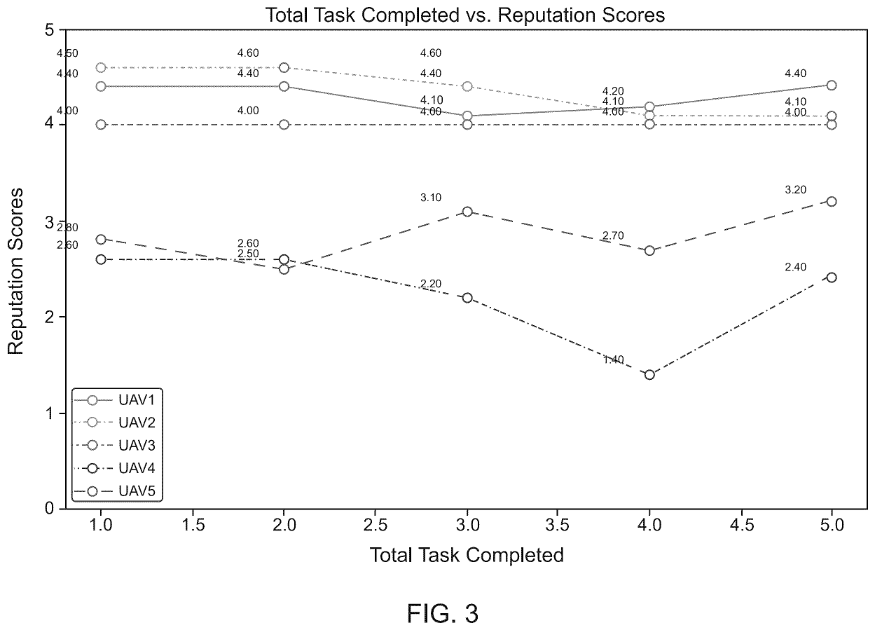

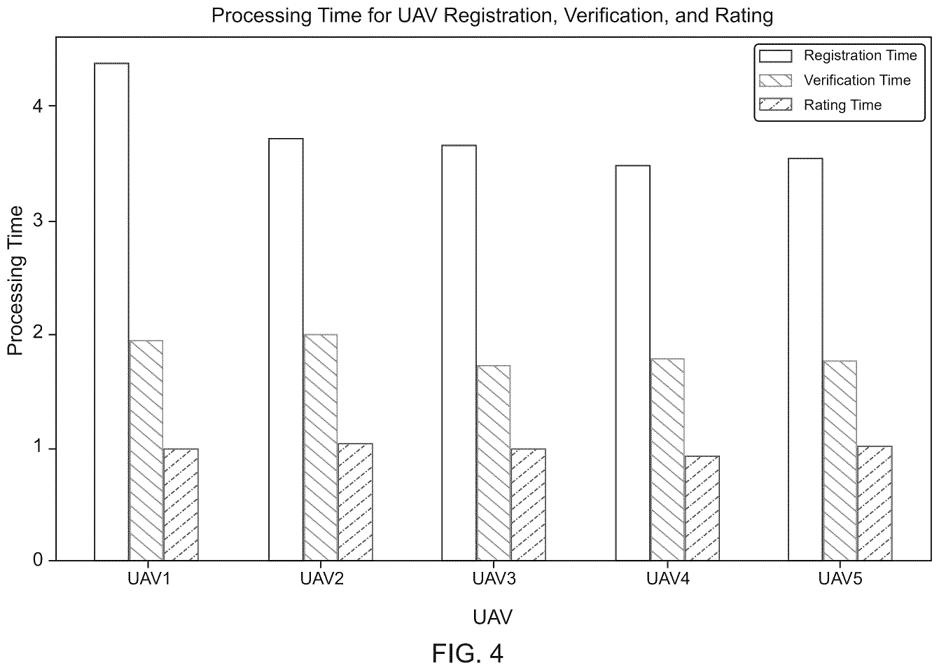

FIG. 3 and FIG. 4 show experimental results of experimentation with a UAV system such as the system 100 of FIG. 1. Algorithms were tested using multiple scenarios of UAV systems and various outputs based on the exemplary algorithms shown herein. Tests can be executed with, for example, a web-based integrated development environment (e.g., a Remix IDE environment) that can be employed for writing, testing, and deploying the smart contracts. This may provide valuable logs for checking the status and results of each operation when debugged.

Simulations can be completed on, for example, a Windows 10 operating system using various programming languages (e.g., Python 3). Various blockchain platforms can be used (e.g., Ethereum). In order to simulate the real-time interaction inherent to blockchain-based systems, nodes can interact with one another through the use of smart contracts issued on a blockchain (e.g., the Ethereum blockchain). Some nodes can serve as Service Providers providing UAV services, while others can perform specialized duties. One or more nodes can be selected for simulation and computation of a reputation score. FIG. 3 shows exemplary results of computations made with various nodes. Reputation values for five nodes are calculated using Equations (1) and (2) shown herein. A reputation score of 5 is considered as being reliable and reputation score below 3 is considered malicious. A node that is considered malicious may be treated as though it sends fake and/or wrong messages to the network.

After implementing the framework, precise results of a node's reputation can be produced. These results may be used to assess whether or not the node is to be trusted. As shown in FIG. 3, Node 1 and Node 2 have a balanced reputation in that they provide both real and fake services in a balanced manner. Also, Node 3's reputation is continually being stabilized as a result of its constant genuine service to the system with a constant rating being given to it. Because of its unreal services, the reputation of Node 5 is continually deteriorating and unreal. However, Node 4 has a fluctuating reputation score as a result of having to deliver both real and fake services to the system, making the curves decrease as well as increase.

As mentioned herein, the level at which the communications are regarded as trustworthy is assumed to be 3.0, and relevant steps are performed. Once UAVs are deemed trusted and reliable, they are permitted to participate in transactions and interactions within the system. These UAVs are granted full access to system resources, enabling them to engage with service requestors and deliver dependable services. By earning this trust, the UAVs become integral components of the network, ensuring the system operates smoothly and securely while maintaining the necessary level of service reliability throughout their interactions. This process ensures that only verified, trusted, and reliable UAVs can contribute to the network, thereby enhancing system integrity and performance. Devices that have a reputation score below this limit are deemed untrustworthy and malicious to the system. These nodes may be isolated so as to prevent an attack on the system. Whether the node is accepted or rejected, the reputation of each node is updated as shown in the flow chart in FIG. 2. The closest the reputation score is to 5, which is assumed to be the optimum reputation score, the more trustworthy the reputation that any given node can have.

The processing times for registration, verification, and the rating process of each UAV node are plotted in FIG. 4. The graph shows that the processing time of UAVs during registration takes an average of 3 seconds to be completed for all the UAVs. Additionally, during the experiments leading to the generation of these graphs, various UAV models with different parameters were used to generate the data. This illustrates that differences in UAV models or other parameters are not necessarily a significant effect on the registration process. A constant processing time suggests that the registration system is well-designed and efficient for the model. With an average processing time of 3 seconds, the registration procedure for all UAVs is relatively fast. An efficient registration system is crucial for UAV operations, as it enables quick deployment and minimizes downtime. Additionally, the verification technique takes an average of 2 seconds for each of the five UAVs. The rating procedure can take 1 second. When the processing times are compared, we can see that the verification and rating operations are both faster than the registration process, which takes an average of 3 seconds. This suggests that the registration process may be more complex or involve additional steps beyond verification and rating.

During registration of an individual UAV's reputation, the requestor node may give feedback on the service provider nodes it has interacted with. This approach can fail if the service provider is not registered in the smart contract. Furthermore, the smart contract's state can be restored if the submitted reputation values are outside of the expected range.

However, if a UAV device has already been registered and verified on the system, any attempt to register the account again either by its name or by the address will cause the transaction to be reversed to its initial state while printing out an error message “UAV is already registered.” When a UAV device with no prior registration history aims at performing some transactions on the network, a reversion to its initial state occurs indicating that the UAV has not been registered.

The aggregation of past and present feedback after being calculated using the reputation calculation can be computed and updated on the reputation contract. Nodes can evidence good behavior by delivering honest and consistent evaluations in a majority of their reputation score submissions. FIG. 3 shows graphs after ratings are submitted for each UAV and reputation score(s) are calculated. After each successful transaction between a service requestor and a service provider, the requestor provides feedback on the provider's performance. This evaluation typically considers key metrics such as the success of the service rendered, the completion rate compared to the expected timeline, and the overall effectiveness and quality of the delivered results. The goal is to capture the performance of the provider by ensuring a comprehensive assessment of their interactions. Each requester who interacts with the provider submits their rating/feedback, contributing to the overall feedback rating. Once all these ratings are collected from different requestors, the provider's overall reputation score is computed using Equation 2. The cumulative score represents the service provider's reliability and effectiveness over time, influencing how future requestors perceive and choose to engage with the provider, thereby impacting the service provider's opportunities for further transactions. The graph shows a plot of the reputation score per total task completed, which shows the interaction between the service providers after each successful transaction. Behaviors of both the malicious devices and the non-malicious devices.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A system comprising:
a UAV network comprising one or more of:
one or more UAVs;
one or more UAV service requestors;
one or more UAV service providers; and
one or more ground stations,
an identity authentication module,
a reputation system module, and
a blockchain fabric module, wherein
the UAVs, the UAV service requesters, the UAV service providers, and the ground stations are capable of sending and receiving electronic data via one or more remote connections,
the identity authentication module identifies and authenticates the UAVs in the UAV network such that only verified and authenticated UAVs are capable of accessing the UAV network;
the reputation system module evaluates and maintains a reputation of one or more of the UAV service requestors and the UAV service providers assigning a reputation rating for one or more of the UAV service requestors and the UAV service providers; and
the blockchain fabric module implements a blockchain with respect to the UAV network to securely record flight data of the UAVs on the UAV network, which flight data includes one or more of a location, altitude, and one or more mission parameters of the UAV.

2. The system of claim 1, wherein the blockchain fabric module comprises a modular framework capable of incorporating one or more modular components including one or more of consensus mechanisms, membership services, and identity management modules.

3. The system of claim 1, wherein the blockchain fabric module is configured to support one or more private channels enabling one or more nodes on the network to conduct transactions without sharing details with the entire network.

4. The system of claim 1, wherein the blockchain fabric module is configured with a membership service provider that manages identities and permissions, ensuring that only authorized nodes can access certain features of the UAV network.

5. The system of claim 1, wherein the blockchain fabric module includes one or more committee-based consensus mechanisms.

6. The system of claim 1, wherein one or more additional nodes may be added to the network based on a reputation of the one or more additional nodes calculated using a reputation score calculation.

7. The system of claim 6, wherein the reputation score calculation is completed, at least in part, by one or more UAVs on the UAV network and includes one or more dynamic weighted factors, the weighted factors based on at least one task of the one or more UAVs.

8. A method of operating a system including:
a UAV network including: one or more UAVs, one or more UAV service requestors, one or more UAV service providers, and one or more ground stations,
an identity authentication module,
a reputation system module, and
a blockchain fabric module,
the method comprising:
registering a first UAV on the UAV network using the identity authentication module, registration of the first UAV including a configuration of node settings for participation in the UAV network;
verifying the first UAV on the UAV network, verification of the first UAV including identity verification using one or more of a public key infrastructure with a cryptographic key or a digital signature;
performing of transaction with the verified first UAV on the UAV network;
updating a reputation of the first UAV on the UAV network by performing a reputation score calculation, an output of the reputation score calculation based on the performance of the transaction by the verified first UAV;
determining whether the first UAV is a malicious actor on the UAV network based, at least in part, on a result of the reputation score calculation;
providing access to the UAV network for the first UAV based on a determination that the first UAV is not a malicious actor and restricting access to the UAV network based on a determination that the first UAV is a malicious actor.

9. The method of claim 8, wherein the reputation score calculation is completed, at least in part, by one or more UAVs on the UAV network and includes one or more dynamic weighted factors, the weighted factors based on a task of the first UAV.

10. The method of claim 9, wherein the reputation score calculation is updated based, at least in part, on a task completion of a task assigned to the first UAV.

11. The method of claim 8, wherein a second UAV provides feedback on a task completion of the first UAV based on the task completion by the first UAV.

12. The method of claim 8, wherein updating a reputation of the first UAV on the UAV network includes presenting aspects associated with the first UAVs participation on the UAV network to a consensus mechanism, the consensus mechanism comprising two or more nodes on the UAV network and configured to analyze the aspects associated with the first UAV's participation on the UAV network and determine a reputation score adjustment for the first UAV.

13. The method of claim 8, wherein the blockchain fabric module is configured to support one or more private channels enabling one or more nodes on the network to conduct transactions without sharing details with the entire network.

14. The method of claim 8, wherein the blockchain fabric module is configured with a membership service provider that manages identities and permissions, ensuring that only authorized nodes can access certain features of the UAV network.
